(19) United States
(12) Patent Application Publication
(10) Pub. No.: US 2026/0362376 A1
(43) Pub. Date: Nov. 12, 2026

(54) METHOD FOR SYNCHRONIZING INFORMATION OF AI-BASED POSITIONING FUNCTION, COMMUNICATION DEVICE AND COMPUTER-READABLE STORAGE MEDIUM

(71) Applicant: BEIJING XIAOMI MOBILE SOFTWARE CO., LTD., Beijing (CN)

(72) Inventor: Qin MU, Beijing (CN)

(73) Assignee: BEIJING XIAOMI MOBILE SOFTWARE CO., LTD., Beijing (CN)

(21) Appl. No.: 19/470,367

(22) PCT Filed: Apr. 6, 2023
(86) PCT No.: PCT/CN2023/086717

§ 371 Date: Sep. 29, 2025

(51) Int. Cl. H04W 64/00; H04B 7/08; H04B 17/318; H04L 41/16; H04W 8/22

(52) U.S. Cl. CPC H04W 64/00; H04B 7/086; H04B 17/328; H04L 41/16; H04W 8/22

(57) ABSTRACT

A method and an apparatus for synchronizing information of AI-based positioning function, a communication device and a computer-readable storage medium are provided. The method includes: sending first information to a network device, where the first information indicates an AI-based positioning function supported by the terminal.

### CROSS-REFERENCE TO RELATED APPLICATIONS

The present application is a U.S. National Phase of International Application No. PCT/CN 2023/086717, filed on Apr. 6, 2023, the entire content of which is incorporated herein by reference for all purposes.

### FIELD

The present disclosure relates to the field of communication technologies, and in particular relates to a method and an apparatus for synchronizing information of an artificial intelligence (AI)-based positioning function.

### BACKGROUND

In recent years, artificial intelligence (AI) technology has made continuous breakthroughs in many fields. The artificial intelligence technology has also been introduced into communication systems, such as research on an AI-based beam management, an AI-based channel state information (CSI) enhancement, an AI-based positioning and the like. In an AI-based deployment solution, an AI model may be deployed on a terminal side, and a network device side also needs to participate in the management of the AI model. Therefore, the network device side and the terminal side need to align the relevant information of the AI model.

### SUMMARY

According to a first aspect of embodiments of the present disclosure, there is provided a method for synchronizing information of an artificial intelligence (AI)-based positioning function, performed by a terminal, including: sending first information to a network device, in which the first information indicates an AI-based positioning function supported by the terminal.

According to a second aspect of embodiments of the present disclosure, there is provided another method for synchronizing information of an artificial intelligence (AI)-based positioning function, performed by a network device, including: receiving first information sent by a terminal; and determining, according to the first information, an AI-based positioning function supported by the terminal.

According to a third aspect of embodiments of the present disclosure, there is provided a communication device that has some or all of the functions of the terminal for implementing the method of the first aspect. For example, the functions of the communication device may have the functions in some or all of embodiments of the present disclosure, or may have the function for implementing any one of embodiments of the present disclosure independently. The functions may be implemented by hardware, or may be implemented by hardware executing corresponding software. The hardware or software includes one or more units or modules corresponding to the functions described above.

In an embodiment, the communication device may include in its structure a transceiver module and a processing module, and the processing module is configured to support the communication device to perform the corresponding functions of the method described above. The transceiver module is configured to support communication between the communication device and other devices. The communication device may further include a storage module, which is configured to couple with the transceiver module and the processing module, and stores computer programs and data necessary for the communication device.

In an embodiment, the communication device includes:
a transceiver module configured to send first information to a network device, in which the first information indicates the AI-based positioning function supported by the terminal.

According to a fourth aspect of embodiments of the present disclosure, there is provided another communication device that has some or all of the functions of the network device for implementing examples of the method of the second aspect. For example, the functions of the communication device may have the functions in some or all of embodiments of the present disclosure, or may have the function for implementing any one of embodiments of the present disclosure independently. The functions may be implemented by hardware, or may be implemented by hardware executing corresponding software. The hardware or software includes one or more units or modules corresponding to the functions described above.

In an embodiment, the communication device may include in its structure a transceiver module and a processing module, and the processing module is configured to support the communication device to perform the corresponding functions of the method described above. The transceiver module is configured to support communication between the communication device and other devices. The communication device may further include a storage module, which is configured to couple with the transceiver module and the processing module, and stores computer programs and data necessary for the communication device.

In an embodiment, the communication device includes:
a transceiver module configured to receive first information sent by a terminal; and
a processing module, configured to determine, according to the first information, an AI-based positioning function supported by the terminal.

According to a fifth aspect of embodiments of the present disclosure, there is provided a communication device including a processor which, when invoking a computer program in a memory, performs the method of the first aspect described above.

According to a sixth aspect of embodiments of the present disclosure, there is provided a communication device including a processor which, when invoking a computer program in a memory, performs the method of the second aspect described above.

According to a seventh aspect of embodiments of the present disclosure, there is provided a communication device, which includes a processor and a memory. A computer program is stored in the memory, and the processor is configured to execute the computer program stored in the memory to cause the communication device to implement the method of the first aspect described above.

According to an eighth aspect of embodiments of the present disclosure, there is provided a communication device, which includes a processor and a memory. A computer program is stored in the memory, and the processor is configured to execute the computer program stored in the memory to cause the communication device to implement the method of the second aspect described above.

According to a ninth aspect of embodiments of the present disclosure, there is provided a communication device, which includes a processor and an interface circuit. The interface circuit is configured to receive code instructions and transmit the code instructions to the processor; and the processor is configured to run the code instructions to cause the device to perform the method of the first aspect described above.

According to a tenth aspect of embodiments of the present disclosure, there is provided a communication device, which includes a processor and an interface circuit. The interface circuit is configured to receive code instructions and transmit the code instructions to the processor; and the processor is configured to run the code instructions to cause the device to perform the method of the second aspect described above.

According to an eleventh aspect of embodiments of the present disclosure, there is provided a communication system, which includes the communication device of the third aspect and the communication device of the fourth aspect, or includes the communication device of the fifth aspect and the communication device of the sixth aspect, or includes the communication device of the seventh aspect and the communication device of the eighth aspect, or includes the communication device of the ninth aspect and the communication device of the tenth aspect.

According to a twelfth aspect of embodiments of the present disclosure, there is provided a computer-readable storage medium configured to store instructions for a terminal as described above, and the instructions, when executed, cause the terminal to perform the method of the first aspect described above.

According to a thirteenth aspect of embodiments of the present disclosure, there is provided a readable storage medium configured to store instructions for a network device as described above that, and the instructions, when executed, cause the network device to perform the method of the second aspect described above.

According to a fourteenth aspect of the present disclosure, there is provided a computer program product including a computer program that, when run on a computer, causes the computer to perform the method of the first aspect described above.

According to a fifteenth aspect of the present disclosure, there is provided a computer program product including a computer program that, when run on a computer, causes the computer to perform the method of the second aspect described above.

According to a sixteenth aspect of the present disclosure, there is provided a chip system including at least one processor and an interface, for supporting a terminal to implement functions involved in the first aspect, for example, determining or processing at least one of data and information involved in the above method. In a possible design, the chip system further includes a memory configured to store computer programs and data necessary for the terminal. The chip system may be composed of chips, or may include chips and other discrete devices.

According to a seventeenth aspect of the present disclosure, there is provided a chip system including at least one processor and an interface, for supporting a network device to implement functions involved in the second aspect, for example, determining or processing at least one of data and information involved in the above method. In a possible design, the chip system further includes a memory configured to store computer programs and data necessary for the network device. The chip system may be composed of chips, or may include chips and other discrete devices.

According to an eighteenth aspect of the present disclosure, there is provided a computer program that, when run on a computer, causes the computer to perform the method of the first aspect described above.

According to a nineteenth aspect of the present disclosure, there is provided a computer program that, when run on a computer, causes the computer to perform the method of the second aspect described above.

### BRIEF DESCRIPTION OF THE DRAWINGS

In order to more clearly illustrate embodiments of the present disclosure or the technical solutions in the related art, drawings to be used for the description of embodiments of the present disclosure or the related art are described below.

FIG. 1 is a schematic architectural diagram illustrating a communication system according to embodiments of the present disclosure;

FIG. 2 is a flowchart illustrating a method for synchronizing information of an artificial intelligence (AI)-based positioning function according to embodiments of the present disclosure;

FIG. 3 is a flowchart illustrating another method for synchronizing information of an artificial intelligence (AI)-based positioning function according to embodiments of the present disclosure;

FIG. 4 is a flowchart illustrating another method for synchronizing information of an artificial intelligence (AI)-based positioning function according to embodiments of the present disclosure;

FIG. 5 is a flowchart illustrating another method for synchronizing information of an artificial intelligence (AI)-based positioning function according to embodiments of the present disclosure;

FIG. 6 is a flowchart illustrating another method for synchronizing information of an artificial intelligence (AI)-based positioning function according to embodiments of the present disclosure;

FIG. 7 is a schematic block diagram illustrating a communication device according to embodiments of the present disclosure;

FIG. 8 is a schematic block diagram illustrating another communication device according to embodiments of the present disclosure; and

FIG. 9 is a schematic block diagram illustrating a chip according to embodiments of the present disclosure.

### DETAILED DESCRIPTION

For ease of understanding, terms to which the present disclosure relates are first introduced.

### 1. Reference Signal

The reference signal is a signal sent by a network device and used to assist a terminal in positioning the terminal according to the measurement of the signal based on an AI positioning model.

### 2. Line of Sight (LOS)

The line of sight is a distance between a transmitting end and a receiving end. A path of a linear propagation signal between the transmitting end and the receiving end without passing through an obstacle is an LOS path, and a reference signal propagating in the LOS path is an LOS path signal. In this case, a propagation distance of the reference signal is a line-of-sight distance, and a propagation mode of the reference signal is a line-of-sight propagation.

### 3. Non Line of Sight (NLOS)

There are obstacles on the connection between the transmitting end and the receiving end of the reference signal, and the reference signal may not propagate between the transmitting end and the receiving end through the line-of-sight propagation. During a propagation process of the reference signal between the transmitting end and the receiving end, the reference signal may only reach the receiving end when it is emitted, scattered or refracted by the obstacles. In this case, the propagation distance of the reference signal is a non-line-of-sight distance, and the propagation mode of the reference signal is non-line-of-sight propagation.

In order to better understand a method and an apparatus for synchronizing information of an artificial intelligence (AI)-based positioning function disclosed in embodiments of the present disclosure, a communication system to which embodiments of the present disclosure are applicable is described below.

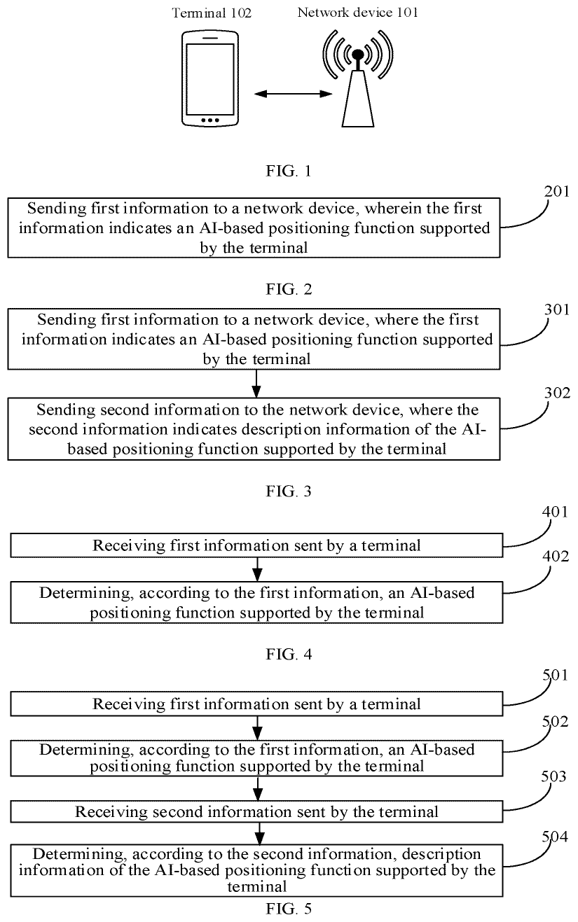

Referring to FIG. 1, FIG. 1 is a schematic architectural diagram illustrating a communication system according to embodiments of the present disclosure. The communication system may include, but is not limited to, a network device and a terminal. The number and form of devices shown in FIG. 1 are for example and do not constitute a limitation on embodiments of the present disclosure. In practical applications, two or more network devices and two or more terminals may be included. As an example for illustration, the communication system shown in FIG. 1 includes a network device 101 and a terminal 102.

It should be noted that the technical solutions of embodiments of the present disclosure may be applied to various communication systems, for example: a long term evolution (LTE) system, a 5th generation (5G) mobile communication system, a 5G new radio (NR) system, or other future new mobile communication systems and the like.

The network device 101 in embodiments of the present disclosure is an entity at a network side for transmitting or receiving signals. The network device 101 may be a base transceiver station (BTS) in a global system for mobile communications (GSM) system or code division multiple access (CDMA), a nodeB (NB) in a wideband code division multiple access (WCDMA) system, an evolved nodeB (eNB) in an LTE system, a radio controller in a cloud radio access network (CRAN) scenario, a radio network controller (RNC), a base station controller (BSC), a home nodeB (HNB) and a baseband unit (BBU). Optionally, the network device may be a relay station, an access point, an in-vehicle device, a wearable device, a network side device in a 5G network or a network side device in a future evolved PLMN network, or the like, an access point (AP) in a WLAN, a wireless relay node, a wireless backhaul node, a transmission point (TP), a transmission and reception point (TRP), or the like, a gNB or a transmission point (TRP or TP) in a new radio system (NR), or one or a group of antenna panels (including multiple antenna panels) of a base station in a 5G system, or may also be a network node constituting a gNB or a transmission point, such as a baseband unit (BBU), or a distributed unit (DU), etc. The specific technology and specific device form adopted by the network device are not limited in the embodiments of the present disclosure. The network device provided by embodiments of the present disclosure may be composed of a central unit (CU) and distributed units (DUs), in which the CU may also be referred to as a control unit. The CU-DU structure allows to split protocol layers of the network device, such as a base station, functions of some protocol layers are centrally controlled in the CU, functions of some or all of the remaining protocol layers are distributed in the DUs, and the CU centrally controls the DUs.

The terminal 102 in embodiments of the present disclosure may be a device that provides voice and/or data connectivity to a user, for example, a handheld device or a vehicle-mounted device with a wireless connection function. Some examples of terminals include: a mobile phone, a tablet computer, a laptop computer, a PDA, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, a cellular phone, a cordless phone, a session initiation protocol (SIP) phone, a wireless local loop (WLL) station, a personal digital assistant (PDA), a handheld device with a wireless communication function, a computing device or other processing devices connected to a wireless modem, a vehicle-mounted device, a wearable device, a terminal device in a 5G network or a terminal device in a future evolved public land mobile communication network (PLMN) and/or any other suitable device for communicating on a wireless communication system, which is not limited in embodiments of the present disclosure.

The wearable device may also referred to as a wearable smart device, which is a general term for the intelligent design and development of the wearable device for daily wear using wearable technology, such as glasses, watches, clothing and shoes. The wearable device is a portable device that is worn directly on the body or integrated into the user's clothes or accessories. The wearable device is not only a hardware device, but also realize a powerful function through software support, data interaction and cloud interaction. In a broad sense, the wearable smart devices include those that are fully functional, large in size, and may achieve complete or partial functions without relying on smartphones, such as smart watches or smart glasses, as well as those that only focus on a certain type of application function and need to be used in conjunction with other devices such as smartphones, such as various smart bracelets and smart jewelry for vital sign monitoring.

In addition, in embodiments of the present disclosure, the terminal 102 may further be a terminal in an Internet of Things system, and Internet of Things (IOT) is an important part of the future development of information technology, and its main technical feature is that articles are connected to the network through communication technology, thereby realizing an intelligent network of human-machine interconnection and object-to-object interconnection.

In addition, in embodiments of the present disclosure, the terminal 102 may further include sensors such as a smart printer, a train detector, and a gas station, and its main functions include collecting data (some terminals), receiving control information and downlink data of the network side device, and sending electromagnetic waves to transmit uplink data to the network side device.

It should be noted that the technical solutions of embodiments of the present disclosure may be applied to various communication systems, for example: a long term evolution (LTE) system, a 5th generation (5G) mobile communication system, a 5G new radio (NR) system, or other future new mobile communication systems and the like.

The terminal 102 provided in embodiments of the present disclosure may perform the method as shown in embodiments of FIGS. 2 to 3, and the network device 101 may perform the method as shown in embodiments of FIGS. 4 to 6.

It may be understood that the communication system described in embodiments of the present disclosure is for a purpose of more clearly illustrating the technical solution of embodiments of the present disclosure, but does not constitute a limitation on the technical solutions provided by embodiments of the present disclosure. Moreover, it is known by those skilled in the art that the technical solutions provided by embodiments of the present disclosure are also applicable to similar technical problems with the evolution of the system architecture and the emergence of new business scenarios.

Further, in order to facilitate understanding of embodiments of the present disclosure, the following description is made.

Firstly, the first, second, and various numerical numbers in the present disclosure are distinguished only for convenience of description, and are not intended to limit the scope of embodiments of the present disclosure, for example, distinguishing different pieces of information, distinguishing different terminals and the like.

Secondly, the “protocol” involved in embodiments of the present disclosure may refer to a standard protocol in the communication field, and may include, for example, an LTE protocol, an NR protocol, and related protocols applied to a future communication system, which is not limited in the present disclosure.

Thirdly, embodiments of the present disclosure lists multiple embodiments to clearly explain the technical solutions of embodiments of the present disclosure. Of course, those skilled in the art may understand that the multiple embodiments provided by embodiments of the present disclosure may be performed alone, or may be performed in combination with possible implementation manners in other embodiments, or may be performed in combination with any technical solution in the related art, which is not limited in embodiments of the present disclosure.

Embodiments of the present disclosure mainly focus on how the terminal synchronizes the function of the AI-based positioning model deployed on the terminal to the network device when the AI-based positioning model is deployed on the terminal side.

Firstly, according to an output result of the positioning model, the AI-based positioning model may be divided into a direct positioning model and an indirect positioning model. The direct positioning model may directly output positioning coordinates of the terminal according to an input parameter, such as coordinate values of the terminal in a global coordinate system; while the indirect positioning model outputs not the positioning coordinates but the parameters required for positioning according to the input parameters. For example, a time of arrival (ToA) of the reference signal, an angle of arrival (AoA) of the reference signal, or a type of transmission path of the reference signal, such as an LOS path or an NLOS path and the like.

In addition, the AI-based positioning models may be divided into multiple AI models in different scenarios according to usage scenarios. For example, an indoor open office (100) and an indoor factory (InF) are included. According to the deployment in the factory, the InF may be further divided into indoor factory high density (inF-DH), indoor factory high sparsity (inF-SH), indoor factory low density (InF-DL), indoor factory low sparsity (inF-SL), and the like. Moreover, in different indoor factory scenarios, the InF may be further subdivided into different supported clutter parameters. Moreover, the performance of the AI-based positioning model may also be affected by network synchronization error, sending and receiving error of terminal and the like.

From the above analysis, it may be seen that an AI feature (such as AI-based positioning) may include one or more functionalities, and each functionality may be targeted at a specific application environment or application scenario. A functionality may include one or more AI models. The present disclosure mainly provides a method for synchronizing information of an AI-based positioning function for various AI-based positioning functions described above. By synchronizing the AI-based positioning function supported by the terminal to the network device, the network device and the terminal have consistent understanding of the AI-based positioning function deployed in the terminal, thereby improving the reliability and accuracy of the AI-based positioning.

The following is a detailed introduction to a method and an apparatus for synchronizing information of an AI-based positioning function provided in the present disclosure with reference to the accompanying drawings.

Referring to FIG. 2, FIG. 2 is a flowchart illustrating a method for synchronizing information of an AI-based positioning function according to embodiments of the present disclosure. As shown in FIG. 2, the method is applied to a terminal, and may include but is not limited to a following step.

In step S201, first information is sent to a network device, in which the first information indicates an AI-based positioning function supported by the terminal.

In some embodiments, the AI-based positioning function supported by the terminal includes at least one of:
output parameters of an AI model including coordinates of the terminal; output parameters of an AI model including arrival time information of a reference signal; output parameters of an AI model including arrival angle information of a reference signal; output parameters of an AI model including a type of a transmission path of a reference signal; or output parameters of an AI model including reference signal receiving power (RSRP).

The type of the transmission path of the reference signal indicates whether the reference signal is an LOS transmission or an NLOS transmission. In some embodiments, the AI model may directly output the type of the transmission path of the reference signal, or may output probabilities corresponding to different types of the transmission paths, which is not limited in the present disclosure.

In some embodiments, the terminal may send the first information to the network device via any type of message. For example, the terminal may send the first information to the network device via a radio resource control (RRC) message.

Optionally, the terminal may also send the first information to the network device via a signaling agreed by a protocol, which is not limited in the present disclosure.

In some embodiments, the terminal may also indicate to the network device the AI-based positioning function supported by the terminal by using a single information unit or several information units in a certain signaling, which is not limited in the present disclosure.

In some embodiments, the terminal may first determine a serial number of the AI-based positioning function supported by the terminal, and then include the serial number of the AI-based positioning function supported by the terminal in the first information sent, thereby reducing a channel resource occupied by sending the first information.

In some embodiments, the AI-based positioning functions supported by the terminal in different frequency ranges may be different, such that the terminal may first determine the AI-based positioning functions supported by the terminal in the different frequency ranges, and then send the first information to the network device on different frequency resources. For example, the first information is sent to the network device on a first frequency resource, in which the first information includes an AI-based positioning function supported by the terminal within a frequency range to which the first frequency resource belongs.

For example, the AI-based positioning function supported by the terminal in a first frequency range is that output parameters of the AI model include coordinates of the terminal (corresponding to a serial number 1), and the AI-based positioning function supported by the terminal in a second frequency range is that output parameters of the AI model include arrival time information of the reference signal and arrival angle information of the reference signal (corresponding to a serial number 2). Therefore, the terminal may send the serial number 2 to the network device on a frequency resource F1 (the F1 belongs to the second frequency range) and the serial number 1 to the network device on a frequency resource F2 (the F2 belongs to the first frequency range).

In summary, the terminal synchronizes the AI-based positioning function supported by the terminal with the network device by sending the first information to the network device, thereby ensuring that the network device has consistent understanding of the AI-based positioning function supported by the terminal with that of the terminal, and ensuring the reliability and accuracy of an AI-based positioning.

Referring to FIG. 3, FIG. 3 is a flowchart illustrating a method for synchronizing information of an AI-based positioning function according to embodiments of the present disclosure. As shown in FIG. 3, the method is applied to a terminal, and may include but is not limited to a following step.

In step S301, first information is sent to a network device, in which the first information indicates an AI-based positioning function supported by the terminal.

The specific implementation of step 301 may refer to the detailed description of other embodiments of the present disclosure and is not repeated here.

In step S303, second information is sent to the network device, in which the second information indicates description information of the AI-based positioning function supported by the terminal.

In some embodiments, the description information includes at least one of:
an applicable application scenario; supported clutter parameters; whether to support working with a network synchronization error; a supported range of a network synchronization error; whether to support working with receiving error or sending error of the terminal; a supported range of receiving error or sending error of the terminal; a type of an input parameter of an AI model; or a dimension of an input parameter of an AI model.

The applicable application scenarios may include whether the AI-based positioning function may be used in scenarios such as IOO, InF-DH, InF-SH, InF-DL, InF-SL, rural, dense urban and the like. If the applicable application scenario indicates support for use in the InF scenario, the clutter parameters supported by the AI-based positioning function may also be included.

Furthermore, the type of the input parameter of the AI model may include RSRP, or may further include a channel impulse response, a channel power distribution, and the like. If the type of the input parameter of the AI model is the channel impulse response or the channel power distribution, the description information may further include a description of whether the input parameter is a continuous time sampling or a discrete time sampling.

The dimension of the input parameter of the AI model is used to describe a collection dimension or a formation dimension of the input parameter, for example, a number of time sampling points corresponding to the input parameter, a number of network devices corresponding to the input parameter, a number of antennas, and the like, which is not limited in the present disclosure.

In summary, the terminal synchronizes the AI-based positioning function supported by the terminal with the network device by sending the first information to the network device, and indicates the description information of the AI-based positioning function supported by the terminal by sending the second information. This enables the network device to have a more comprehensive understanding of the AI-based positioning function supported by the terminal, further improving the reliability and accuracy of an AI-based positioning.

Referring to FIG. 4, FIG. 4 is a flowchart illustrating a method for synchronizing information of an AI-based positioning function according to embodiments of the present disclosure. As shown in FIG. 4, the method is applied to a network device, and may include but is not limited to a following step.

In step S401, first information sent by a terminal is received.

In step S402, an AI-based positioning function supported by the terminal is determined according to the first information.

In some embodiments, the AI-based positioning function supported by the terminal includes at least one of:
output parameters of an AI model including coordinates of the terminal; output parameters of an AI model including arrival time information of a reference signal; output parameters of an AI model including arrival angle information of a reference signal; output parameters of an AI model including a type of a transmission path of a reference signal; or output parameters of an AI model including RSRP.

The type of the transmission path of the reference signal indicate whether the reference signal is an LOS transmission or an NLOS transmission. In some embodiments, the AI model may directly output the type of the transmission path of the reference signal, or may output probabilities corresponding to different types of the transmission paths, which is not limited in the present disclosure.

In some embodiments, the network device may receive the first information sent by the terminal via any type of message. For example, the network device may receive the first information sent by the terminal via an RRC message.

Optionally, the network device may also receive the first information sent by the terminal via a signaling agreed by a protocol, which is not limited in the present disclosure.

In some embodiments, the network device may also determine the AI-based positioning function indicated and supported by the terminal according to a content carried by a single information unit or several information units in a certain signaling, which is not limited in the present disclosure.

In some embodiments, the first information received by the network device includes a serial number of the AI-based positioning function supported by the terminal. Afterwards, the network device may determine the AI-based positioning function supported by the terminal according to a mapping relationship between the serial number and the AI-based positioning function, thereby reducing a channel resource occupied by sending the first information.

In some embodiments, the network device may also receive multiple pieces of first information sent by the terminal on different frequency resources, and then determine the AI-based positioning function supported by the terminal in the different frequency ranges according to the frequency range and the first information to which each frequency resource belongs. For example, the first information sent by the terminal is received on a first frequency resource, in which the first information includes an AI-based positioning function supported by the terminal within a frequency range to which the first frequency resource belongs.

For example, the network device receives a serial number 2 sent by the terminal on a frequency resource F1 (the F1 belongs to the second frequency range), and receives a serial number 1 sent by the terminal on a frequency resource F2 (the F2 belongs to the first frequency range). A positioning function of the AI model corresponding to the serial number 1 is: the output parameters of the AI model including the coordinates of the terminal, and a positioning function of the AI model corresponding to the serial number 2 is: the output parameters of the AI model including the arrival time information and the arrival angle information of the reference signal. Therefore, the network device may determine that the AI-based positioning function supported by the terminal within the first frequency range is: the output parameters of the AI model including the coordinates of the terminal (corresponding the serial number 1), and the AI-based positioning function supported by the terminal within the second frequency range is: the output parameters of the AI model including the arrival time information and the arrival angle information of the reference signal (corresponding the serial number 2).

In summary, the network device determines the AI-based positioning function supported by the terminal by receiving the first information sent by the terminal, thereby ensuring that the network device has consistent understanding of the AI-based positioning function supported by the terminal with that of the terminal, and ensuring the reliability and accuracy of an AI-based positioning.

Referring to FIG. 5, FIG. 5 is a flowchart illustrating a method for synchronizing information of an AI-based positioning function according to embodiments of the present disclosure. As shown in FIG. 5, the method is applied to a network device, and may include but is not limited to a following step.

In step S501, first information sent by a terminal is received.

In step S502, an AI-based positioning function supported by the terminal is determined according to the first information.

The specific implementations of step 501 and step 502 may refer to the detailed description of other embodiments of the present disclosure and are not repeated here.

In step S503, second information sent by the terminal is received.

In step S504, description information of the AI-based positioning function supported by the terminal is determined according to the second information.

In some embodiments, the description information includes at least one of:
an applicable application scenario; supported clutter parameters; whether to support working with a network synchronization error; a supported range of a network synchronization error; whether to support working with receiving error or sending error of the terminal; a supported range of receiving error or sending error of the terminal ; a type of an input parameter of an AI model; or a dimension of an input parameter of an AI model.

The applicable application scenarios may include whether the AI-based positioning function may be used in scenarios such as IOO, InF-DH, InF-SH, InF-DL, InF-SL, rural, dense urban and the like. If the applicable application scenario indicates support for use in the InF scenario, the clutter parameters supported by the AI-based positioning function may also be included.

Furthermore, the type of the input parameter of the AI model may include RSRP, or may further include a channel impulse response, a channel power distribution, and the like. If the type of the input parameter of the AI model is the channel impulse response or the channel power distribution, the description information may further include a description of whether the input parameter is a continuous time sampling or a discrete time sampling.

The dimension of the input parameter of the AI model is used to describe a collection dimension or a formation dimension of the input parameter, for example, a number of time sampling points corresponding to the input parameter, a number of network devices corresponding to the input parameter, a number of antennas, and the like, which is not limited in the present disclosure.

In summary, the network device determines the AI-based positioning function supported by the terminal by receiving the first information sent by the terminal, and determines the description information of the AI-based positioning function supported by the terminal by receiving the second information. This enables the network device to have a more comprehensive understanding of the AI-based positioning function supported by the terminal, further improving the reliability and accuracy of an AI-based positioning.

Referring to FIG. 6, FIG. 6 is a flowchart illustrating a method for synchronizing information of an AI-based positioning function according to embodiments of the present disclosure. As shown in FIG. 6, the method is applied to a network device, and may include but is not limited to a following step.

In step S601, first information sent by a terminal is received.

In step S602, an AI-based positioning function supported by the terminal is determined according to the first information.

The specific implementations of step 601 and step 602 may refer to the detailed description of other embodiments of the present disclosure and are not repeated here.

In step S603, a capability supported by the terminal is determined according to a capability associated with each AI-based positioning function and the AI-based positioning function supported by the terminal.

In some embodiments, the network device may determine the capability associated with each AI-based positioning function according to a protocol or a preset rule. The capabilities associated with different AI-based positioning functions may be the same or different, which is not limited in the present disclosure.

In some embodiments, the capability associated with the AI-based positioning function includes at least one of:
supporting a channel impulse response of continuous time sampling;
supporting a channel power distribution of continuous time sampling;
at least supporting working in an indoor scene; or
supporting a network synchronization error within a specified period of time.

The specified period of time may be agreed by a protocol or may be preset in the network device, which is not limited in the present disclosure. For example, if the specified period of time is 1 nanosecond (ns), the network device may determine the AI-based positioning function supported by the terminal, and support to work under the condition of network synchronization error within 1 ns.

In summary, after receiving the first information sent by the terminal, the network device may determine the AI-based positioning function supported by the terminal, and then determine the capability supported by the terminal according to the capability associated with each AI-based positioning function and the AI-based positioning function supported by the terminal. This not only ensures that the network device has consistent understanding of the AI-based positioning function supported by the terminal with that of the terminal, but also ensures that the network device may determine its positioning capability according to the AI-based positioning function supported by the terminal, thereby further improving the reliability and accuracy of an AI-based positioning.

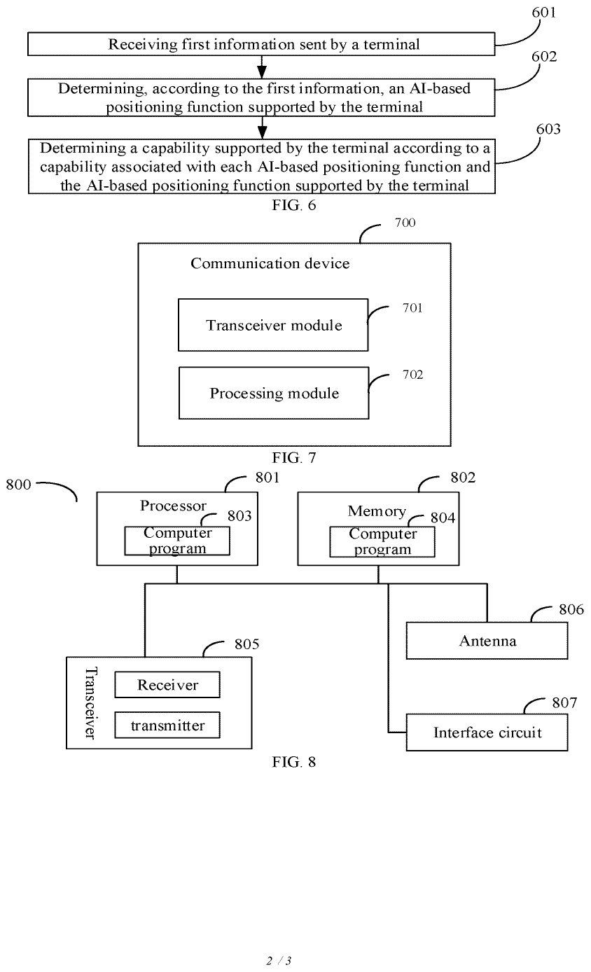

Referring to FIG. 7, FIG. 7 is a schematic block diagram illustrating a communication device according to embodiments of the present disclosure. The communication device 700 shown in FIG. 7 may include a transceiver module 701 and a processing module 702. The transceiver module may include a sending module and/or a receiving module. The sending module is configured to implement a sending function, and the receiving module is configured to implement a receiving function. The transceiver module may implement a sending function and/or a receiving function.

The communication device 700 may be a terminal, or may be an apparatus in a terminal, or may be an apparatus that may be used in cooperation with a terminal.

The communication device 700 is a terminal:
the transceiver module 701 is configured to send first information to a network device, in which the first information indicates the AI-based positioning function supported by the terminal.

In some embodiments, the AI-based positioning function includes at least one of:
output parameters of an AI model including coordinates of the terminal; output parameters of an AI model including arrival time information of a reference signal; output parameters of an AI model including arrival angle information of a reference signal; output parameters of an AI model including a type of a transmission path of a reference signal; or output parameters of an AI model including RSRP.

In some embodiments, the transceiver module 701 is further configured to send second information to the network device, in which the second information indicates description information of the AI-based positioning function supported by the terminal.

In some embodiments, the description information includes at least one of:
an applicable application scenario; supported clutter parameters; whether to support working with a network synchronization error; a supported range of a network synchronization error; whether to support working with receiving error or sending error of the terminal; a supported range of receiving error or sending error of the terminal; a type of an input parameter of an AI model; or a dimension of an input parameter of an AI model.

In some embodiments, the transceiver module 701 is further configured to send the first information to the network device via a signaling agreed by a protocol.

In some embodiments, the first information includes a serial number of the AI-based positioning function supported by the terminal.

In some embodiments, the transceiver module 701 is further configured to send, on a first frequency resource, the first information to the network device, in which the first information includes an AI-based positioning function supported by the terminal within a frequency range to which the first frequency resource belongs.

In summary, the terminal synchronizes the AI-based positioning function supported by the terminal with the network device by sending the first information to the network device, thereby ensuring that the network device has consistent understanding of the AI-based positioning function supported by the terminal with that of the terminal, and ensuring the reliability and accuracy of an AI-based positioning.

The communication device 700 may be a network device, or may be an apparatus in a network device, or may be an apparatus that may be used in cooperation with a network device.

The communication device 700 is a network device:
the transceiver module 701 is configured to receive first information sent by a terminal; and
the processing module 702 is configured to determine, according to the first information, an AI-based positioning function supported by the terminal.

In some embodiments, the AI-based positioning function includes at least one of:
output parameters of an AI model including coordinates of the terminal; output parameters of an AI model including arrival time information of a reference signal; output parameters of an AI model including arrival angle information of a reference signal; output parameters of an AI model including a type of a transmission path of a reference signal; or output parameters of an AI model including RSRP.

In some embodiments, the transceiver module 701 is further configured to receive second information sent by the terminal; and
the processing module 702 is further configured to determine, according to the second information, description information of the AI-based positioning function supported by the terminal.

In some embodiments, the description information includes at least one of:

an applicable application scenario; supported clutter parameters; whether to support working with a network synchronization error; a supported range of a network synchronization error; whether to support working with receiving error or sending error of the terminal; a supported range of receiving error or sending error of the terminal; a type of an input parameter of an AI model; or a dimension of an input parameter of an AI model.

In some embodiments, the transceiver module 701 is further configured to receive the first information sent by the terminal via a signaling agreed by a protocol.

In some embodiments, the first information includes a serial number of the AI-based positioning function supported by the terminal.

In some embodiments, the transceiver module 701 is further configured to receive, on a first frequency resource, the first information sent by the terminal, in which the first information includes an AI-based positioning function supported by the terminal within a frequency range to which the first frequency resource belongs.

In some embodiments, the processing module 702 is further configured to determine a capability supported by the terminal according to a capability associated with each AI-based positioning function and the AI-based positioning function supported by the terminal.

In some embodiments, the capability associated with the AI-based positioning function includes at least one of:
supporting a channel impulse response of continuous time sampling;
supporting a channel power distribution of continuous time sampling;
at least supporting working in an indoor scene; or
supporting a network synchronization error within a specified period of time.

In summary, the network device determines the AI-based positioning function supported by the terminal by receiving the first information sent by the terminal, thereby ensuring that the network device has consistent understanding of the AI-based positioning function supported by the terminal with that of the terminal, and ensuring the reliability and accuracy of an AI-based positioning.

Referring to FIG. 8, FIG. 8 is a schematic block diagram illustrating another communication device 800 according to embodiments of the present disclosure. The communication device 800 may be a network device; a terminal; a chip, a chip system or a processor supporting the network device to implement the above-mentioned method; or a chip, a chip system or a processor supporting the terminal to implement the above-mentioned method. The communication device 800 may be configured to implement the method as described in above method embodiments, with particular reference to the description of method embodiments described above.

The communication device 800 may include one or more processors 801. The processor 801 may be a general-purpose processor or a special-purpose processor, etc. It may be, for example, a baseband processor or a central processor. The baseband processor may be configured to process a communication protocol and communication data, and the central processor may be configured to control a communication device (such as a base station, a baseband chip, a terminal, a terminal chip, a DU or a CU, etc.), execute a computer program and process data of the computer program.

In some embodiments, the communication device 800 may further include one or more memories 802 on which the computer program 804 may be stored, and the memory 802 executes the computer program 804 to cause the communication device 800 to perform the method as described in above method embodiments. In some embodiments, the memory 802 may also have the data stored therein. The communication device 800 and the memory 802 may be provided independently or integrated together.

In some embodiments, the communication device 800 may further include a transceiver 805 and an antenna 806. The transceiver 805 may be referred to as a transceiver unit, a transceiver machine, or a transceiver circuit for implementing a transceiving function. The transceiver 805 may include a receiver and a transmitter, the receiver may be referred to as a receiving machine or a receiving circuit or the like for implementing a receiving function; and the transmitter may be referred to as a transmitting machine or a transmission circuit or the like for implementing a transmitting function.

In some embodiments, the communication device 800 may further include one or more interface circuits 807. The interface circuit 807 is configured to receive code instructions and transmit the code instructions to the processor 801. The processor 801 executes the code instructions to cause the communication device 800 to perform the method described in above method embodiments.

In an embodiment, the processor 801 may further include the transceiver for implementing receiving and transmitting functions. For example, the transceiver may be a transceiver circuit, or an interface, or an interface circuit. The transceiver circuit, interface, or interface circuit for implementing the receiving and transmitting functions may be separated or integrated. The transceiver circuit, interface or interface circuit may be configured to read and write code/data, or the transceiver circuit, interface or interface circuit may be configured for transmission or transfer of signals.

In an embodiment, the processor 801 may have stored therein the computer program 803 that, when run on the processor 801, causes the communication device 800 to perform the method described in above method embodiments. The computer program 803 may be solidified in the processor 801, in which case the processor 801 may be implemented in hardware.

In an embodiment, the communication device 800 may include a circuit that may implement a transmitting, receiving or communicating function in foregoing method embodiments. The processor and transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be fabricated with various IC process technologies such as complementary metal oxide semiconductor (CMOS), n-metal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device in above embodiments may be the network device or the terminal, but the scope of the communication device described in the present disclosure is not limited thereto. Moreover, the structure of the communication device may not be limited by FIG. 8. The communication device may be a stand-alone device or may be a part of a larger device. For example, the communication device may be:
(1) a stand-alone integrated circuit (IC), or a chip, or a chip system or a subsystem;
(2) a set of one or more ICs, optionally the set of ICs may also include a storage component for storing the data and the computer program;
(3) ASIC, such as modem;
(4) a module that may be embedded in other devices;
(5) a receiver, a terminal, an intelligent terminal, a cellular phone, a wireless device, a handset, a mobile unit, an on-vehicle device, a network device, a cloud device, an artificial intelligence device, etc. ; or
(6) others.

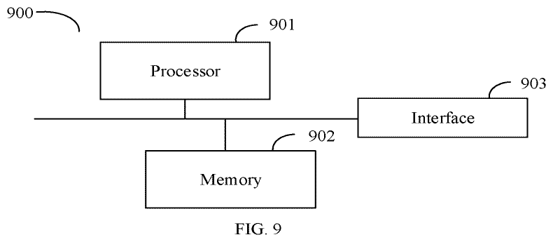

In a case where the communication device may be the chip or the chip system, reference may be made to the schematic block diagram of the chip shown in FIG. 9.

The chip 900 includes a processor 901 and an interface 903. There may be one or more processors 901 and a plurality of interfaces 903.

Regarding a case where the chip is configured to implement the functions of the terminal in embodiments of the present disclosure:
the interface circuit 903 is configured to receive code instructions and transmit the code instructions to a processor; and
the processor 901 is configured to execute the code instructions to perform the method for synchronizing information of the AI-based positioning function as described in some of the above embodiments.

Regarding a case where the chip is configured to implement the functions of the network device in embodiments of the present disclosure:
the interface circuit 903 is configured to receive code instructions and transmit the code instructions to a processor; and
the processor 901 is configured to execute the code instructions to perform the method for synchronizing information of the AI-based positioning function as described in some of the above embodiments.

In some embodiments, the chip 900 further includes the memory 902 for storing necessary computer programs and data.

Those skilled in the art may further appreciate that the various illustrative logical blocks and steps described in embodiments of the present disclosure may be implemented in electronic hardware, computer software, or combinations of both. Whether such functionality is implemented as hardware or software depends upon particular application and design requirement of the overall system. Those skilled in the art may implement the described functionality in varying ways for each particular application, but such implementation should not be considered to be beyond the scope of protection of embodiments of the present disclosure.

Embodiments of the present disclosure further provide a communication system, the system includes the communication device as the terminal and the communication device as the network device described in forgoing embodiments of FIG. 7, or the system includes the communication device as the terminal and the communication device as the network device described in forgoing embodiments of FIG. 8.

The present disclosure further provides a readable storage medium having instructions stored thereon that, when executed by a computer, causes the functions of any of the method embodiments described above to be implemented.

The present disclosure also provides a computer program product that, when executed by a computer, causes the functions of any of the method embodiments described above to be implemented.

The above embodiments may be implemented in whole or in part by software, hardware, firmware or any combination thereof. When implemented using the software, the above embodiments may be implemented in whole or in part in a form of the computer program product. The computer program product includes one or more computer programs. When the computer programs are loaded and executed on the computer, all or part of the processes or functions according to embodiments of the present disclosure will be generated. The computer may be a general purpose computer, a special purpose computer, a computer network, or other programmable devices. The computer programs may be stored in a computer-readable storage medium or transmitted from one computer-readable storage medium to another computer-readable storage medium. For example, the computer programs may be transmitted from one website site, computer, server or data center to another website site, computer, server or data center in a wired manner (such as via a coaxial cable, an optical fiber, a digital subscriber line (DSL)) or a wireless manner (such as via infrared, wireless, or microwave, etc.). The computer-readable storage medium may be any available medium that may be accessed by the computer, or a data storage device such as a server or a data center integrated by one or more available media. The available medium may be a magnetic medium (for example, a floppy disk, a hard disk, or a magnetic tape), an optical medium (for example, a high-density digital video disc (DVD)), or a semiconductor medium (for example, a solid state disk (SSD)), etc.

Those of ordinary skill in the art may understand that the first, second, and other numeral numbers involved in the present disclosure are for convenience of description, and are not intended to limit the scope of embodiments of the present disclosure, nor are they intended to represent a sequential order.

The term “at least one” used in the present disclosure may also be described as one or more, and the term “a plurality of” may cover two, three, four or more. Terms “and/or” describe an association relationship of associated objects, representing that there may be three kinds of relationships. For example, A and/or B may represent three cases, that is, A alone, A and B simultaneously, and B alone. The character “/” generally represents that context objects are an “or” relationship. The term “at least one of . . . ” or similar expressions refers to any combination of these items, including any combination of single items or plural items. For example, at least one of a, b or c may represent: a, or b, or c, or a and b, or a and c, or b and c, or a, b and c, in which a, b and c may be single or plural, which is not limited in the present disclosure. In embodiments of the present disclosure, for a certain kind of technical features, the technical features in this kind of technical features are distinguished by terms like “first”, “second”, “third”, “A”, “B”, “C” and “D”, etc., and these technical features described with the “first”, “second”, “third”, “A”, “B”, “C” and “D” have no order of priority and have no order of size.

The correspondence shown in each table in the present disclosure may be configured or predefined. The values of various information in each table are examples, and may be configured as other values, which are not limited in the present disclosure. When configuring a correspondence between the information and various parameters, it is not necessary to configure all the correspondences shown in the tables. For example, the correspondences shown in some rows of a table in the present disclosure may not be configured. For another example, appropriate deformations or adjustments (such as splitting, merging, and so on) may be made based on the above table. The names of parameters shown in the titles of the above tables may adopt other names understandable by the communication device, and the values or representations of the parameters may also be other values or representations understandable by the communication device. When the above tables are implemented, other data structures may also be used, for example, arrays, queues, containers, stacks, linear tables, pointers, linked lists, trees, graphs, structural body, classes, heaps, or hash tables may be used.

The term “predefinition” in the present disclosure may be understood as definition, predefinition, storage, pre-storage, pre-negotiation, pre-configuration, curing, or pre-firing.

Those of ordinary skill in the art can appreciate that the units and algorithm steps of various examples described in conjunction with embodiments disclosed herein may be implemented by the electronic hardware, or a combination of the computer software and the electronic hardware. Whether these functions are executed by the hardware or the software depends on the specific applications and design constraints of the technical solution. For each particular application, those skilled in the art may use different methods to implement the described functions, but such implementation should not be considered beyond the scope of the present disclosure.

Those skilled in the art can clearly understand that for the convenience and brevity of the description, the specific working process of the above-described system, device and unit may refer to the corresponding process in the foregoing method embodiments, which is not repeated here.

The above has described some specific embodiments of the present disclosure, but the scope of the present disclosure is not limited thereto. Any person skilled in the art may easily think of changes or substitutions within the technical scope of the present disclosure, which shall be covered by the protection scope of the present disclosure. Therefore, the protection scope of the present disclosure shall be in line with the attached claims.

1. A method for synchronizing information of an artificial intelligence (AI)-based positioning function, performed by a terminal, comprising:
sending first information to a network device, wherein the first information indicates an AI-based positioning function supported by the terminal.

2. The method according to claim 1, wherein the AI-based positioning function comprises at least one of:
output parameters of an AI model comprising coordinates of the terminal; output parameters of an AI model comprising arrival time information of a reference signal; output parameters of an AI model comprising arrival angle information of a reference signal; output parameters of an Al model comprising a type of a transmission path of a reference signal; or output parameters of an AI model comprising reference signal receiving power (RSRP).

3. The method according to claim 1, further comprising:
sending second information to the network device, wherein the second information indicates description information of the AI-based positioning function supported by the terminal.

4. The method according to claim 3, wherein the description information comprises at least one of:
an applicable application scenario; supported clutter parameters; whether to support working with a network synchronization error; a supported range of a network synchronization error; whether to support working with receiving error or sending error of the terminal; a supported range of receiving error or sending error of the terminal; a type of an input parameter of an AI model; or a dimension of an input parameter of an AI model.

5. The method according to claim 1, wherein sending the first information to the network device comprises:
sending the first information to the network device via a signaling agreed by a protocol.

6. The method according to claim 1, wherein the first information comprises a serial number of the AI-based positioning function supported by the terminal.

7. The method according to claim 1, wherein sending the first information to the network device comprises:
sending, on a first frequency resource, the first information to the network device, wherein the first information comprises an AI-based positioning function supported by the terminal within a frequency range to which the first frequency resource belongs.

8. A method for synchronizing information of an artificial intelligence (AI)-based positioning function, performed by a network device, comprising:
receiving first information sent by a terminal; and
determining, according to the first information, an AI-based positioning function supported by the terminal.

9. The method according to claim 8, wherein the Al-based positioning function comprises at least one of:
output parameters of an AI model comprising coordinates of the terminal; output parameters of an AI model comprising arrival time information of a reference signal; output parameters of an AI model comprising arrival angle information of a reference signal; output parameters of an AI model comprising a type of a transmission path of a reference signal; or output parameters of an AI model comprising reference signal receiving power (RSRP).

10. The method according to claim 8, further comprising:
receiving second information sent by the terminal; and
determining, according to the second information, description information of the AI-based positioning function supported by the terminal.

11. The method according to claim 10, wherein the description information comprises at least one of:
an applicable application scenario; supported clutter parameters; whether to support working with a network synchronization error; a supported range of a network synchronization error; whether to support working with receiving error or sending error of the terminal; a supported range of receiving error or sending error of the terminal; a type of an input parameter of an AI model; or a dimension of an input parameter of an AI model.

12. The method according to claim 8, wherein receiving the first information sent by the terminal comprises:
receiving the first information sent by the terminal via a signaling agreed by a protocol.

13. The method according to claim 8, wherein the first information comprises a serial number of the AI-based positioning function supported by the terminal.

14. The method according to claim wherein receiving the first information sent by the terminal comprises:
receiving, on a first frequency resource, the first information sent by the terminal, wherein the first information comprises an AI-based positioning function supported by the terminal within a frequency range to which the first frequency resource belongs.

15. The method according to claim 8, further comprising:
determining a capability supported by the terminal according to a capability associated with each AI-based positioning function and the AI-based positioning function supported by the terminal.

16. The method according to claim 15, wherein the capability associated with the AI-based positioning function comprises at least one of:
supporting a channel impulse response of continuous time sampling;
supporting a channel power distribution of continuous time sampling;
at least supporting working in an indoor scene; or
supporting a network synchronization error within a specified period of time.

17-18. (canceled)

19. A communication device, comprising:
a processor; and
a memory storing instructions executable by the processor,
wherein the processor is configured to:
send first information to a network device, wherein the first information indicates an AI-based positioning function supported by the terminal.

20-21. (canceled)

22. A non-transitory computer-readable storage medium for storing instructions that, when executed by at least one processor, cause the method according to claim 1 to be implemented.

23. A communication device, comprising:
a processor; and
a memory storing instructions executable by the processor,
wherein the processor is configured to perform the method according to claim 8.

24. A non-transitory computer-readable storage medium for storing instructions that, when executed by at least one processor, cause the method according to claim 8 to be implemented.
